(19) United States
(12) Patent Application Publication
(10) Pub. No.: US 2010/0241902 A1
(43) Pub. Date: Sep. 23, 2010

(54) System and method for performing automated testing of protective relay equipment

(76) Inventors: Scott Gilbertson, Burlington (CA); Christopher Douglas Werstiuk, Denver, CO (US); John Scott Cooper, Saint Petersburg, FL (US)

Correspondence Address: DOWELL & DOWELL P.C., 103 Oronoco St., Suite 220, Alexandria, VA, 22314, US

(21) Appl. No.: 12/656,725

(22) Filed: Feb. 16, 2010

Related U.S. Application Data
(60) Provisional application No. 61/202,305, filed on Feb. 17, 2009.

(51) Int. Cl. G06F 11/07

(52) U.S. Cl. 714/33; 714/E11.029

(57) ABSTRACT

A system and method are provided that avoid the need to tether a computer to a test set in order to run a test sequence on a protective relay and obtain result data. A decoupling can be performed by generating command files that can be placed in storage media or provided to the test set separately rather than sending timed commands directly from the computer to the test set. Similarly, a result file generator on the test set can obtain test results and generate a result file that can be placed in such storage media or transported separately to be used by a reporting tool on the computer in the normal fashion. It has been found that various ways of decoupling are possible, using any suitable transport scheme including physical and electronic, both wired and wireless.

This application claims priority from U.S. Provisional Patent Application No. 61/202,305 filed on Feb. 17, 2009, the contents of which are incorporated herein by reference.

### FIELD OF THE INVENTION

The present invention relates generally to electrical power system protection and control, and has particular utility in performing automated testing of protective relay equipment.

### DESCRIPTION OF THE PRIOR ART

Electrical power systems typically make use of protection systems for increasing the reliability of the power system's infrastructure. A common component of such protection systems includes a protective relay, which, in general, monitors the current and voltage at a particular node in the power system, and, if a fault is detected, provides one or more trip signals to trip a circuit breaker in order to isolate a portion of the system. Often, more than one protective relay is needed to completely isolate a portion of the system, which may be a 3-phase power line, a generator, a transformer etc.

Most power utilities engage in a routine testing program, requiring each protective relay or group of relays to be tested periodically. For this purpose, they employ primary injection, or more typically secondary injection test equipment. Primary injection test equipment applies voltages and currents on the high-voltage or high-current side of each potential transformer (PT) or current transformer (CT). Secondary injection test equipment applies lower voltages and lower currents to the low-voltage side of each PT and the low-current side of each CT.

The test equipment generates waveforms similar in amplitude (current or voltage), frequency, phase angle, and wave shape, to those which would be applied to the protective relays in various fault scenarios. For example, the generated waveforms may be similar to those which would be measured by the protective relays when a conductive object makes contact with a power transmission line, causing current to flow from the line to the ground.

The test equipment monitors the outputs of the protective relays, which may be contact closures, voltage changes or “virtual” points asserted over a communication link. Typical test equipment has the ability to measure the time between the application of fault simulation waveforms and the assertion of outputs by the protective relays. In that way, various errors can be detected, including failure of an output to assert, spurious assertion of the output, early assertion of the output, or late assertion of the output. A pass or fail assessment can then be made, based on the expected operation of the protective relays according to the system design for the power substation.

The routine testing schedule can require test technicians to execute a large number of tests at each substation, and many of the tests can only be carried out while the substation, or part of it, is off-line. The utility is often required to restrict the amount of time for which circuits are out of service, so the testing proceeds rapidly in order to be completed before the end of the circuit outage. Outages are typically scheduled well in advance of the actual outage date. In some cases an approved outage planned a year in advance is cancelled at the last moment due to unexpected demand on the power system due to weather or unanticipated system conditions.

Utilities therefore require the ability to execute a large number of tests during a short period of time.

To that end, automated testing software is often employed. The software runs on a personal computer (typically a laptop computer, for portability) tethered to the test set via a communications link such as RS-232 or Ethernet. The software can be pre-configured to contain all the test sequences required to test a particular power circuit, so that during the outage the test technician can execute the tests in rapid succession, gathering test result data in the process. The configuration of test sequences and analysis of test result data can be done before and after the outage, rather than during the outage.

To prepare for testing, the protection technician sets up the test equipment and then isolates the protection by opening the blocking switches connected to the trip outputs of the relay. Next, the current transformer (CT) and potential transformer (PT) signals are isolated from the relay. The output signals from the test set are then connected in place of the now isolated CT and PT signals. Finally, the output signals from the relay are connected to the status input terminals of the test set.

During each test, the automated test software communicates with the test equipment, sending waveform generation parameters and retrieving protective relay operation events. At the conclusion of the test, the automated test software records the test results on the personal computer, and displays them to the test technician. During an outage, many such tests are performed, and the results are accumulated on the personal computer.

The power utility often requires the test technician to generate printed reports documenting the test results. The automated test software typically includes the ability to print reports at a later time, after all the tests are complete.

Currently, for the test equipment or “test set” to be used, a series of timed commands are sent to the test set and events received as they occur. This requires a PC or other computing device to be brought out to the field, tethered to the test set, and remain connected for the duration of the test run. Moreover, the PC is typically a portable unit such as a laptop and may have limited computing power or limited access to corporate database servers and other resources.

It is an object of the following to address the above-noted disadvantages.

### SUMMARY OF THE INVENTION

In one aspect, there is provided a method for performing protective relay testing, the method comprising: a test program operable with a test set obtaining a command file, the command file comprising a test case description; the test program using the command file to enable the test set to run a test on a protective relay via a test interface; the test program obtaining from the test interface, events associated with the test being run on the protective relay; and the test program providing the events to a result file generate for generating a result file indicative of results of the test, wherein the result file is configured to enable a separate computer to generate a report.

In another aspect, there is provided a method for enabling the performance of protective relay testing, the method comprising: obtaining a test set definition indicative of operations to be performed by a test set for the protective relay testing; obtaining a test case description indicative of the nature of the test to be performed; generating a command file comprising a test case description by converting the test case description from an internal format to a format understood by the test set using the test set definition; and outputting the command file to enable the command file to be provided to the test set.

In yet another aspect, there is provided a computer readable storage medium comprising computer executable instructions for performing protective relay testing, the computer readable storage medium comprising instructions for: obtaining a command file, the command file comprising a test case description; using the command file to enable the test set to run a test on a protective relay via a test interface; obtaining from the test interface, events associated with the test being run on the protective relay; and providing the events to a result file generate for generating a result file indicative of results of the test, wherein the result file is configured to enable a separate computer to generate a report.

In yet another aspect, there is provided a computer readable storage medium comprising computer executable instructions for enabling the performance of protective relay testing, the computer readable storage medium comprising instructions for: obtaining a test set definition indicative of operations to be performed by a test set for the protective relay testing; obtaining a test case description indicative of the nature of the test to be performed; generating a command file comprising a test case description by converting the test case description from an internal format to a format understood by the test set using the test set definition; and outputting the command file to enable the command file to be provided to the test set.

### BRIEF DESCRIPTION OF THE DRAWINGS

Embodiments will now be described by way of example only with reference to the appended drawings wherein:

FIG. 1 is a schematic diagram of an end to end testing arrangement for a high voltage power line.

FIG. 2 is a waveform illustrating pre-fault, fault and post-fault current and voltage signals.

FIG. 3 is a schematic block diagram of a protective relay under test and test equipment therefor.

FIG. 4 is a schematic block diagram of a prior art set up for controlling a test set using a tethered computer.

FIG. 5 is a block diagram showing the decoupling of a test set from a computer and use of command files and result files for running and recording the results of a test.

FIG. 6 is a block diagram of the command file generator shown in FIG. 5.

FIG. 7 is a flow chart showing computer executable operations performed by the command file generator shown in FIG. 6.

FIG. 8 is a block diagram of the test program shown in FIG. 5.

FIG. 9 is a flow chart showing computer executable operations performed by the test program shown in FIG. 8.

FIG. 10 is a block diagram of the result file generator shown in FIG. 5.

FIG. 11 is a flow chart showing computer executable operations performed by the result file generator shown in FIG. 10.

FIG. 12 is a block diagram of the reporting tool shown in FIG. 5.

FIG. 13 is a flow chart showing computer executable operations performed by the reporting tool shown in FIG. 12.

FIGS. 14 to 16 are block diagrams illustrating a sequence of steps performed in one embodiment for decoupling the computer from the test set according to FIG. 5.

FIG. 17 is a block diagram illustrating a sequence of steps performed in another embodiment for decoupling the computer from the test set according to FIG. 5.

FIG. 18 is a block diagram illustrating a sequence of steps performed in yet another embodiment for decoupling the computer from the test set according to FIG. 5.

FIG. 19 is a block diagram illustrating a sequence of steps performed in yet another embodiment for decoupling the computer from the test set according to FIG. 5.

### DETAILED DESCRIPTION OF THE INVENTION

It has been recognized that to avoid the need to tether a computer to a test set in order to run a test sequence and obtain result data, a decoupling can be performed by generating command files that can be placed in storage media or provided to the test set separately rather than sending timed commands directly from the computer to the test set. Similarly, a result file generator on the test set can obtain test results and generate a result file that can be placed in such storage media or transported separately to be used by a reporting tool on the computer in the normal fashion. It has been found that various ways of decoupling are possible, using any suitable transport scheme including physical and electronic, both wired and wireless.

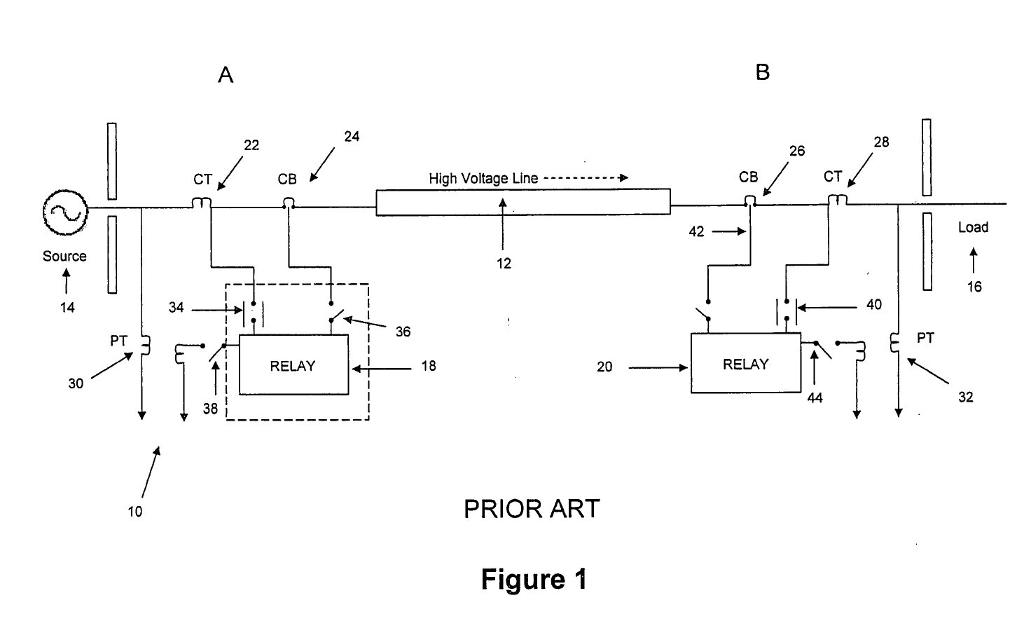

Referring first to FIG. 1, an exemplary protective relay testing arrangement as is known in the prior art is generally denoted by numeral 10. In this example, a high voltage transmission line 12 between a power source 14 and a load 16 is protected by a first protective relay 18 towards the source end of the line 12 (denoted by “A”), and a second protective relay 20 towards the load end of the line 12 (denoted by “B”). It will be appreciated that the line 12 is shown as a single phase or “1 line” transmission line for clarity only and that the line 12 may be instead (and is typically) a three phase or “3 line” transmission line. It will also be appreciated that the testing arrangement 10 is applicable to any portion of a power system infrastructure such as a generator, transformer etc.

Endpoint A of the testing arrangement 10 comprises an inline current transformer (CT) 22 for measuring current in the line 12, and a circuit breaker 24 for isolating the line 12. Similarly, endpoint B comprises a breaker 26 and CT 28 to complete the isolation. Each end also comprises a potential transformer (PT) 30 and 32 respectively for measuring voltage in the line 20. The first relay 18 at end A is connected to the CT 22 to measure current through push switch 34, is connected to the circuit breaker 36 to provide a trip signal for tripping the breaker 36 through on/off switch 36, and is connected to the PT 30 to measure voltage through on/off switch 38. It will be appreciated that the second relay 20 is connected to the circuit breaker 26, CT 28 and PT 32 in a similar manner, namely through push switch 40, on/off switch 42, and on/off switch 44 respectively.

The protective relays 18, 20 are complex electromechanical apparatus, often having more than one coil, and are designed to calculate operating conditions on the transmission line 12, and trip the circuit breakers 24, 26 when a fault is found. Unlike switching type relays with fixed and usually ill-defined operating voltage thresholds and operating times, the protective relays 18, 20 typically have well-established, selectable, time/current (or other operating parameter) curves. The protective relays 18, 20 are generally important to the reliability of the transmission infrastructure (including transmission line 12) and thus it is important that they are operating correctly.

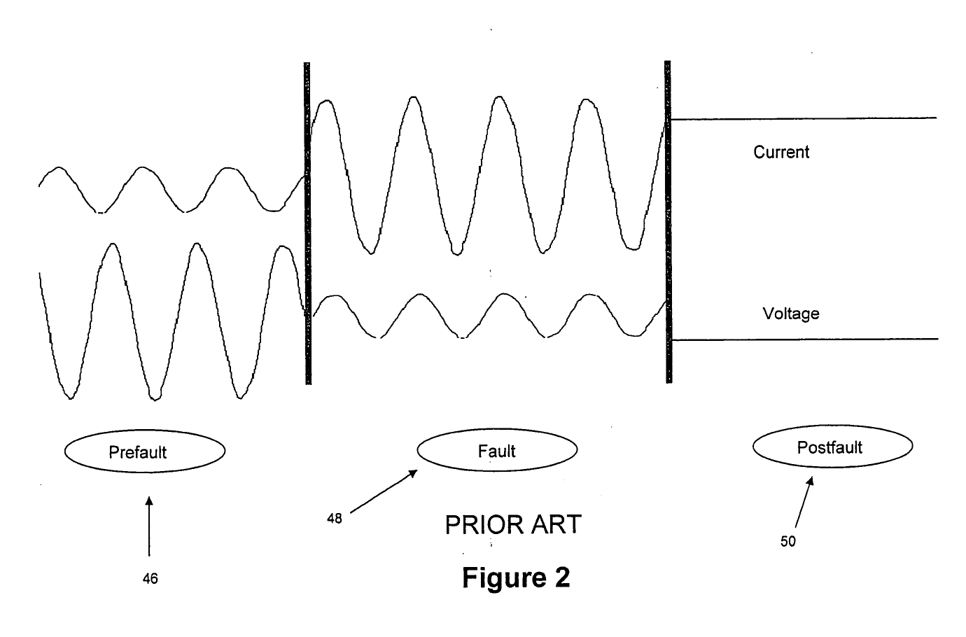

FIG. 2 shows voltage and current waveforms in a pre-fault stage 46 where the normal, expected sinusoidal waveforms are shown, during a common fault 48 (e.g. where an obstruction contacts the line 12), where the current rises dramatically as the voltage decreases, until a post fault stage 50 where the protection trips the breakers associated with the faulted section of the line 12 isolating the faulted section and causing the current and voltage to effectively go to zero.

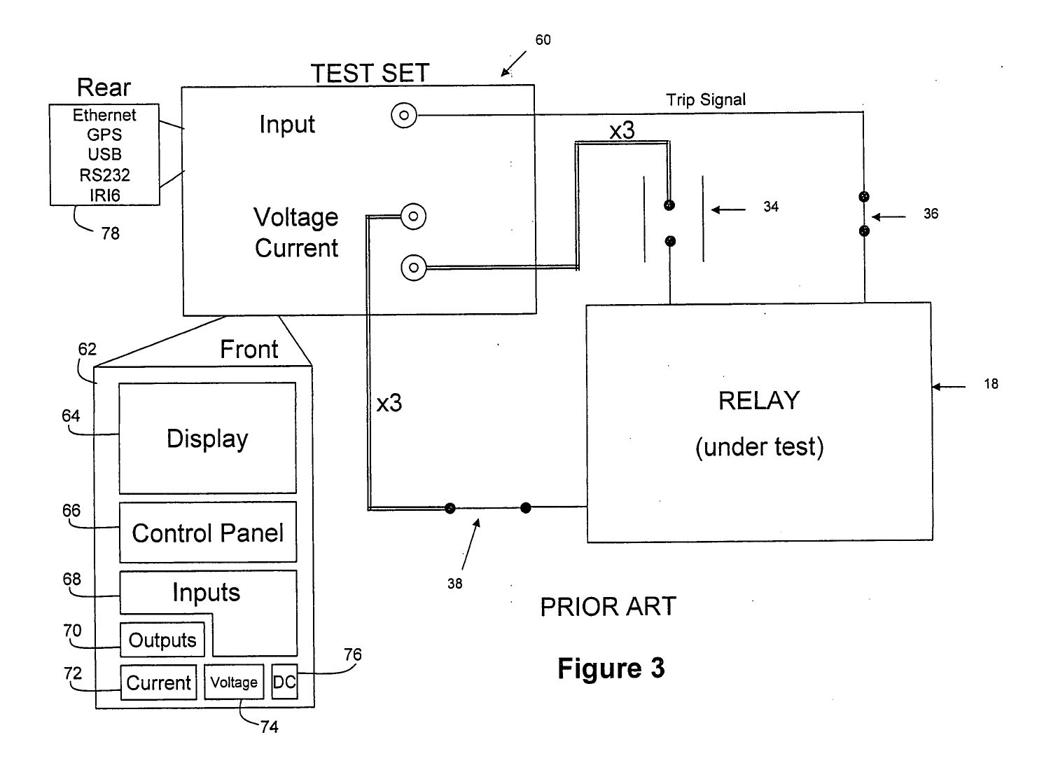

As discussed above, and shown generally by way of example only in FIG. 3, protective relay testing may be accomplished by connecting the protective relay 18, 20 to a protective relay testing system or test set 60. As shown in FIG. 3, a voltage output from the test set 60 is connected to the switch 38, a current output from the test set 60 is connected to switch 34 and the trip signal provided through switch 36 on the relay 18 is connected to an input to the test set 60. It will be appreciated that typically the voltage and current outputs are for three phase circuits and thus such connections would typically include three connections per voltage and three connections per current. The input and voltage and current outputs are shown in general in FIG. 3 and further detail regarding these connections is provided below.

As shown schematically in FIG. 3, the test set 60 is housed in a structural casing or box, the front panel 62 of which provides, for the user, a display 64 for displaying textual and graphical interfaces. The display 64 is typically a liquid crystal display (LCD) and may itself provide an input mechanism by being a touch-screen. The test set 60 also comprises an input panel 66 which may comprise any number of and/or combination of input mechanisms such as a keypad, scroll wheel, trackball, rotary knob, push buttons, arrow keys, touch screen etc. The input panel 66 enables the user, in conjunction with the display 64, to interact with the test set 60, provide commands, give feedback, receive feedback etc.

The front panel 62 also provides n status inputs 68, e.g. n=12, for measuring various signals during the fault test; and m output contacts 70, e.g. m=4, for outputting various signals to simulate events that would be seen by the relay 18 in an actual fault. An example would be feedback indicating whether or not the breaker is open or closed. In this example, the test set 60 performs fault testing on a 3 phase transmission line 12 and thus the front panel 62 would also comprises 3 AC current outputs 72, and 3 AC voltage outputs 74 as indicated in FIG. 3. The front panel further comprises a DC voltage output 76 for powering the relay under test 18 or for providing voltage to the output contacts for powering other devices.

The tester 60 houses various electronic components as is well known in the art. An input/output (I/O) board provides a bridge between the inputs 68, outputs 70-76, input panel 66 and display 64, on the front panel 62, and an interface printed circuit board (PCB). The interface PCB is used to translate external connections to internal connections and routes the signals to the appropriate locations. Central to the operation of the tester 60 is a central processing unit (CPU), which includes a field programmable gate array (FPGA) connected thereto. The CPU and FPGA communicate with the interface PCB for interacting with inputs and outputs; a GPS receiver for receiving accurate time signals for end to end testing routines; and a communications interface PCB and external communications panel 78 (e.g. rear panel as shown), for uploading and downloading data and communicating with various media. The communication panel may be compatible with various communication standards, such as Ethernet, universal serial bus (USB), GPS, RS-232 (serial) and Inter-Range Instrumentation Group (IRIG). The CPU also has access to non-volatile memory such as flash or a hard drive and to volatile memory such as random access memory (RAM).

The tester 60 may also include a variable voltage power supply, which connects to an external power source through a power factor correction (PFC) circuit. The power supply typically powers a series of convertible amplifiers. Each amplifier has a serial data link to the interface PCB to obtain waveform data information, and provides an output to the appropriate contact on the front panel 62, through the I/O board.

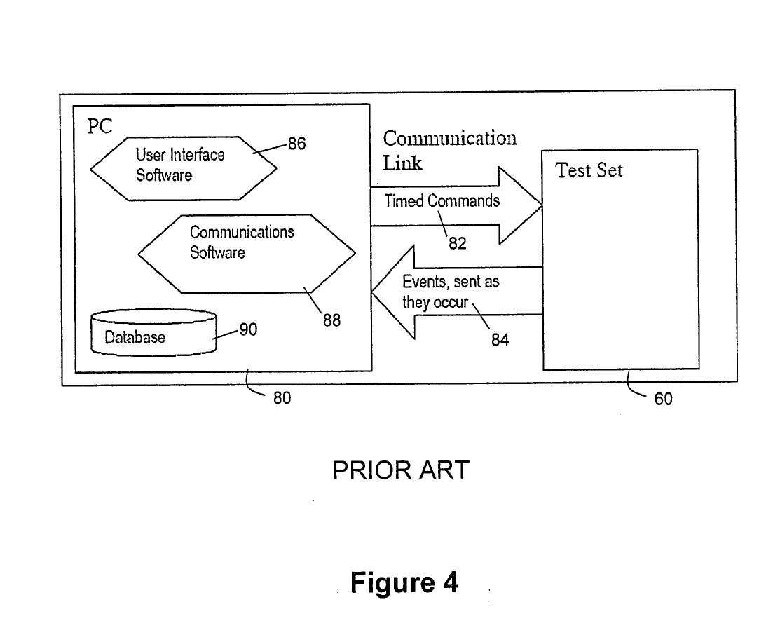

Turning now to FIG. 4, as discussed above, currently, a computer (PC) 80 is brought to the test set 60 and tethered thereto in order to transmit a sequence of timed commands 82 to the test set 60 for running a test and to receive events (results) 84 generated and transmitted by the test set 60 back to the PC 80 as they occur. In such arrangements, the PC 80 must remain connected to the test set 60 for the duration of the test. The PC 80 comprises user interface software 86 for enabling a user to interact with the test set 60, and a database 90 for storing commands, test sequences, result data, etc.

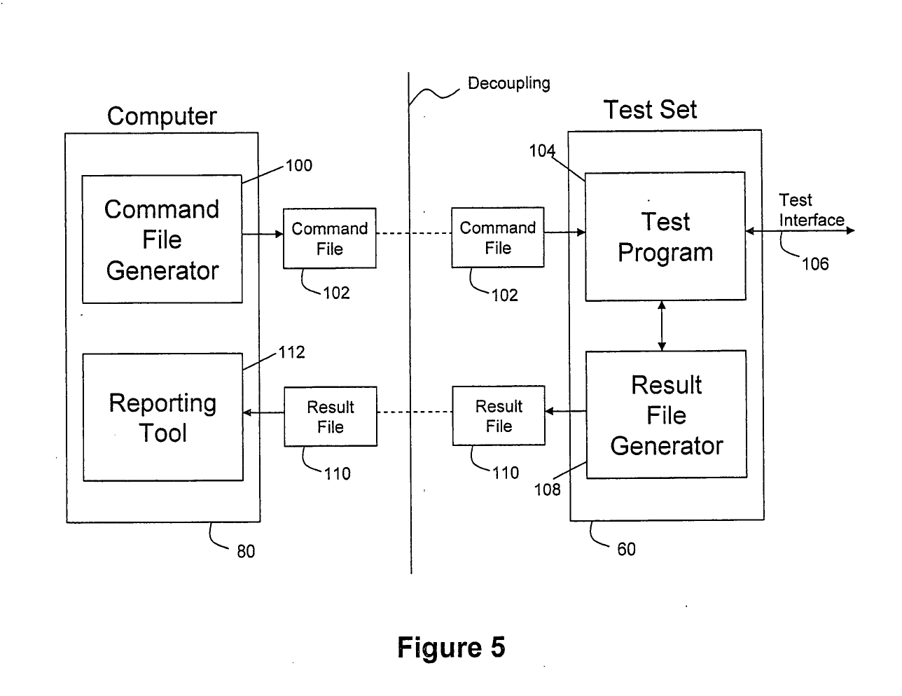

Rather than requiring the PC 80 to be directly connected to the test set 60 as shown in FIG. 4, a decoupling can be performed as shown in FIG. 5 by providing a command file generator 100 to enable the test execution commands to be incorporated into a command file 102 that can instruct a test program 104, in the test set 60, how to run the desired test. The test program 104 may be any software module or program, whether included in existing software or implemented separately that is capable of interpreting commands included in the command file 102, interfacing with the equipment to be tested over a standard test interface 106 and, during the test, obtain events pertaining to the test that can be provided to a result file generator 108 in order to generate a result file 100. By running the test from the command file 102 and by generating a result file 110 on the test set 60, the PC 80 can be decoupled from the test set 60 and thus is not required on site. Instead, the command files 102 and result files 110 are transported between the computer 80 and the test set 60 in any number of suitable ways, including physical transport and electronic transport as will be exemplified below.

By decoupling the PC 80 and test set 60 in this way, the PC 80 is not limited by a requirement of portability and thus can be a desktop computer connected to corporate servers, databases and have access to other resources. Also, it can be appreciated that separate computers 80 can be used to generate command files 102 and to interpret result files 110, e.g. if one entity designs the test while another is responsible for interpreting and reporting. This allows a separation of duties for running a test and recording events. Moreover, by pre-generating the command files 102, such command files 102 can be created and stored in advance to suit testing schedules and to remove the reliance on the presence of a properly loaded computer 80.

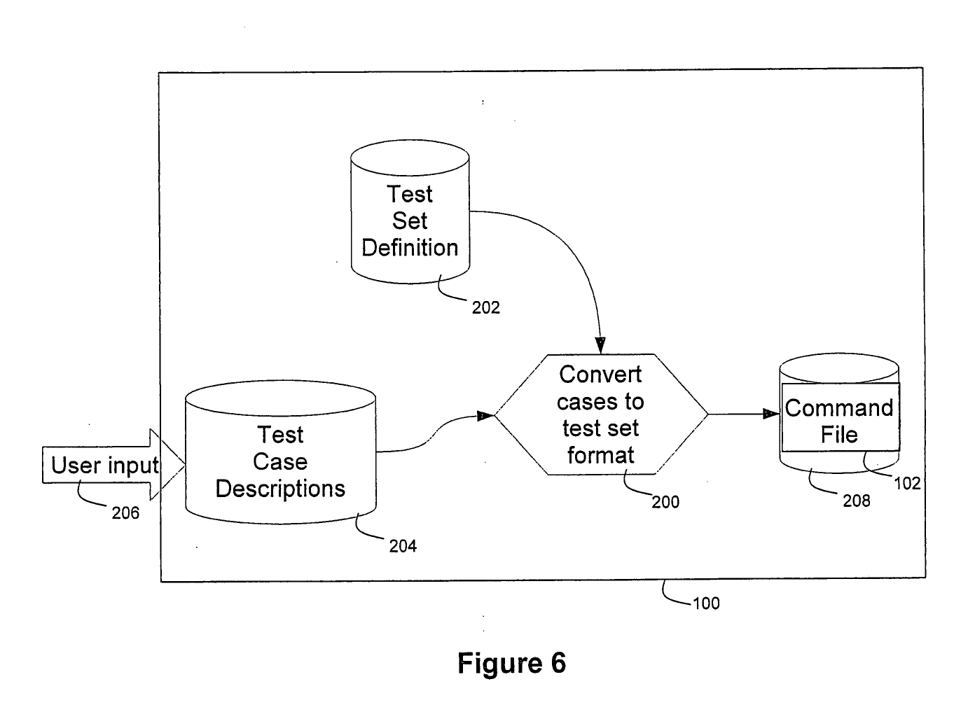

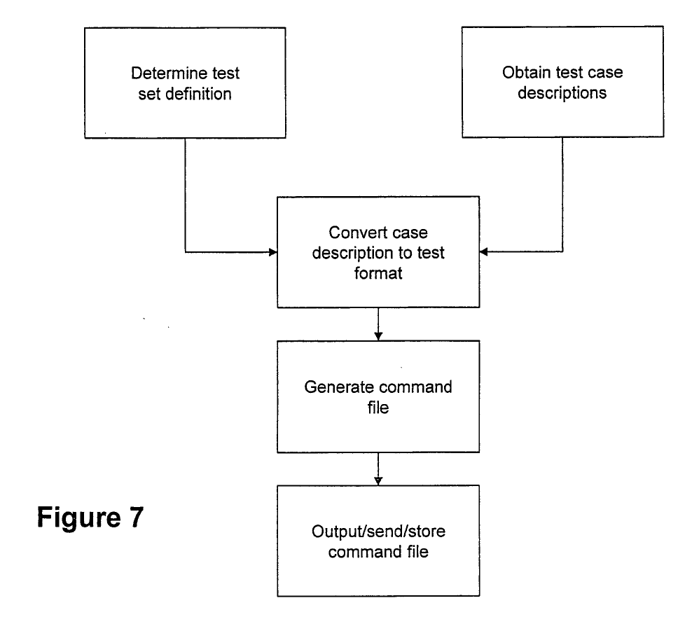

Further detail of the command file generator 100 is shown in FIGS. 6 and 7. The command file generator 100 in this example comprises a database or file storage of test case descriptions 204, which may be entered via user input 206 and describe the nature of the test to be performed; a database or file storage comprising a test set definition 202, which defines the operations performed by the test set 60; and a conversion module 200 for converting test case descriptions 204 from an internal format to the format understood by the test set 60. The conversion module 200 outputs command files 102 thus generated to a database or file storage 208, which enables the command files 102 to be accessed and transported to the test set 60. As can be seen in FIG. 7, the command file generator 100 can be operated to obtain one or more test case descriptions 204, e.g. via user input 206 and access the test set definition 202 to determine the mapping from the internal format used in the test case description 204 to the format that will be used by the test set 60. Upon converting the test case description 204 to the test format, the command file 102 is generated and such command file 102 output, sent or stored. It will be appreciated that although the databases or file storage modules shown in FIG. 6 are shown within the boundary defining the command file generator 100, any of these databases or file storage modules may instead be external to the command file generator 100 to suit a particular application.

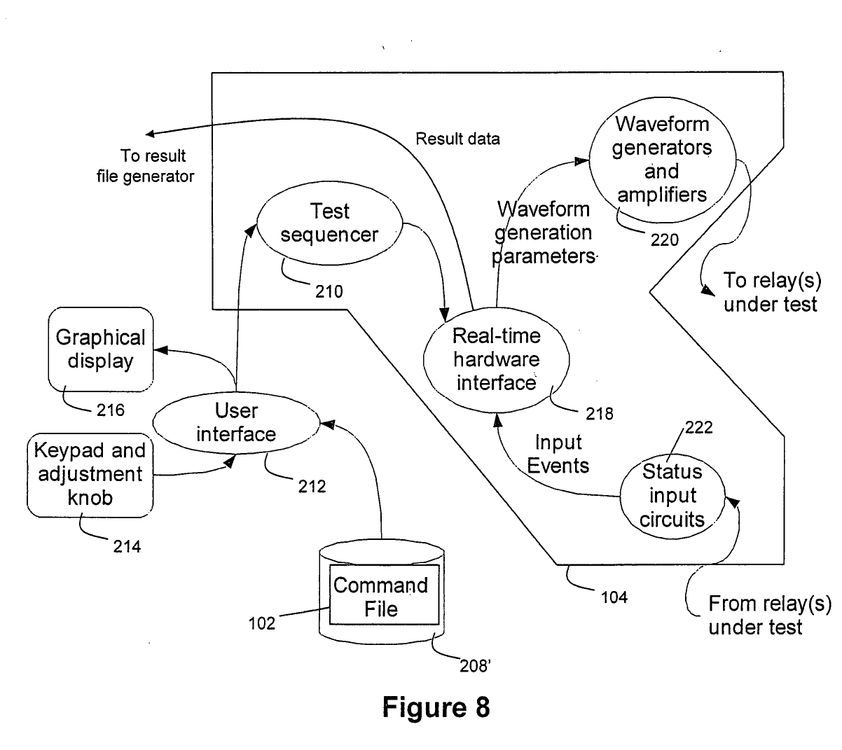

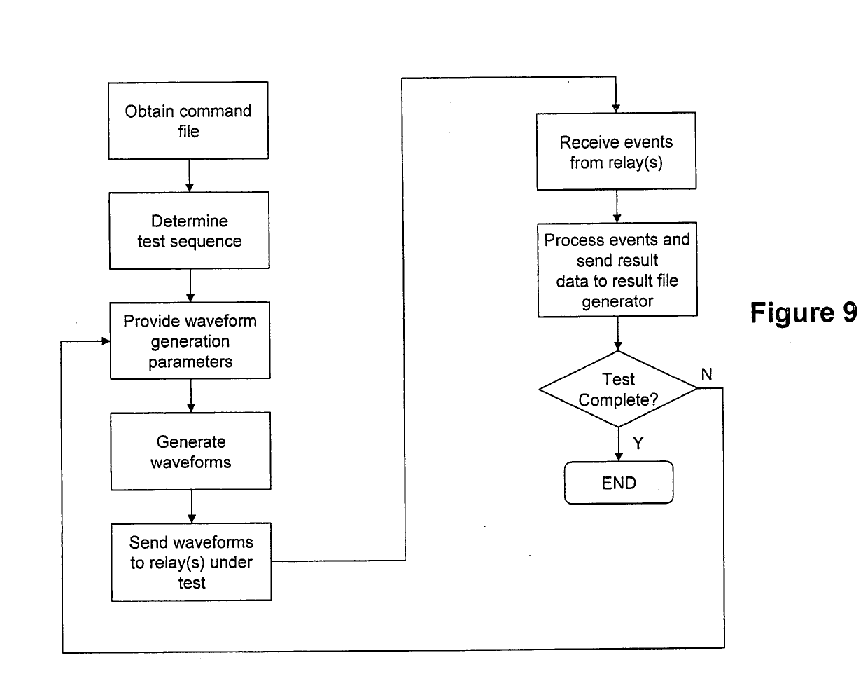

Turning now to FIGS. 8 and 9, further detail pertaining to the test program 104 residing on the test set 60, is shown. As best seen in FIG. 8, the test program 104 may interact with a user interface 212 (e.g. display 64, control panel 66, inputs 68, etc.), which in this example accepts keypad and adjustment knob inputs 214 and provides graphical display feedback/outputs 216 to the user. The user interface 212 is also used in this example to obtain a command file 102 from a file storage 208′, which may be the same file storage 208 shown in FIG. 6, a copy thereof, or a different file storage device, either physical or virtual. A test sequencer 210 uses a real-time hardware interface 218 to execute commands provided by the command file 102. This allows waveform generation parameters to be provided to waveform generators and amplifiers 220, which send such waveforms to the relay(s) under test 18, 20. The test program 104 also comprises status input circuitry 222 to obtain timing measurements and other data from the relay(s) under test 18, 20 and provide events to the real-time hardware interface 218. The real-time hardware interface 218 may then pass along or, if necessary format or process result data to be sent to the result file generator 108.

As shown in FIG. 9, the test program 104 first obtains a command file 102 and, through the user interface 212 and per the command file 102, determines a test sequence to be performed. The test program 104 may then execute a test case under user control via the user interface 212. As the test case is performed, the waveform and generation parameters are provided to the generators and amplifiers 220 and the appropriate waveforms generated. The waveforms are then sent or otherwise provided to the relay(s) under test 18, 20. As events are generated, they are then received by the status and input circuits 222 and events processed and sent to the result file generator 108. The test is performed under either the user or the command file (or both) indicates that the test is complete, otherwise, the next set of waveforms are sent to the relay(s) under test 18, 20. It will be appreciated that although the test case is executed in this example under user control, fully automated or a hybrid of automatic and manual executions may be performed in various applications.

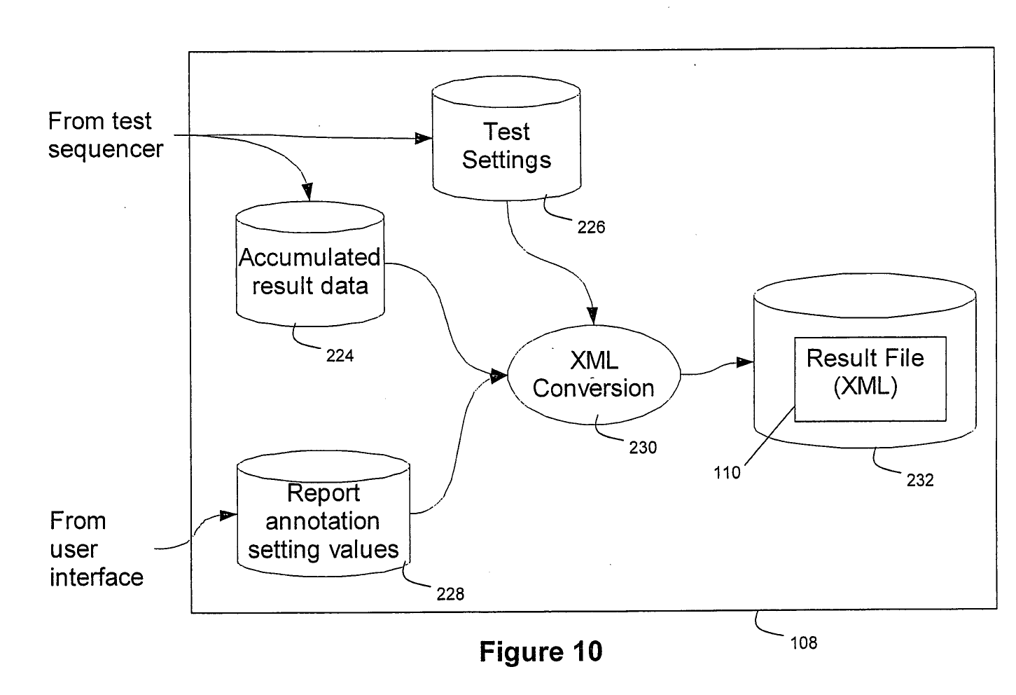

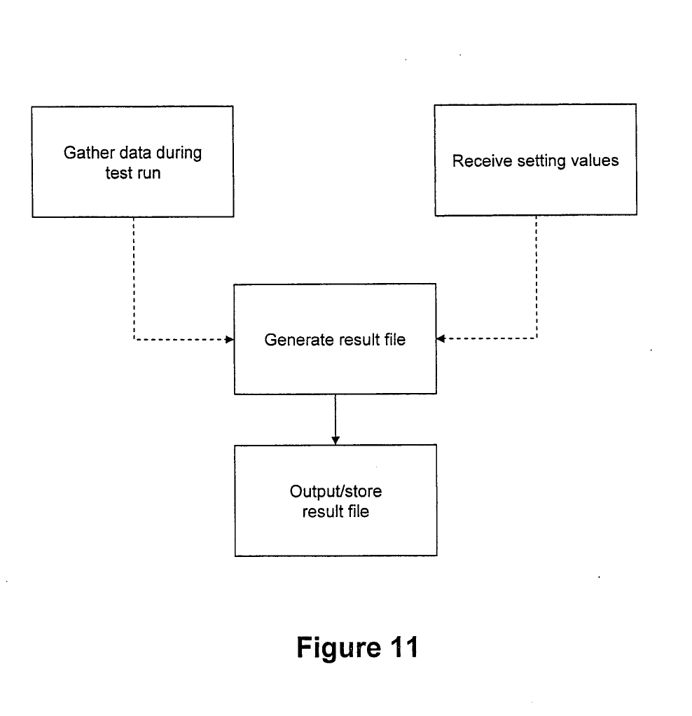

FIGS. 10 and 11 illustrate further detail pertaining to the result file generator 108. As shown in FIG. 10, the result file generator 108 contains or otherwise has access to test settings 226 and accumulated result data 224 obtained from the test sequencer 210 in the test program 104, and report annotation setting values 228 obtained via user input, e.g. through the user interface 212. The result file generator 230 also comprises, in this example, an XML conversion module 230, which converts result data to a result file 110, in this example, having an XML format. The result file generator 230 also comprises or otherwise has access to a result file database or file storage module 232, typically for temporary storage of result files 110 before they are transmitted/transported back to the computer 80. As seen in FIG. 11, the result file generator 108 consolidates data 224 gathered during the course of the test run, along with settings 226 that were used for the test and produces a result file 110 (e.g. XML file) containing such data along with any report annotation setting values, so that it can be kept together for use by the reporting tool 112, e.g. by outputting and/or storing the result file 110 for transmission or transport. It will be appreciated that although the databases or file storage modules shown in FIG. 10 are shown within the boundary defining the result file generator 108, any of these databases or file storage modules may instead be external to the result file generator 108 to suit a particular application.

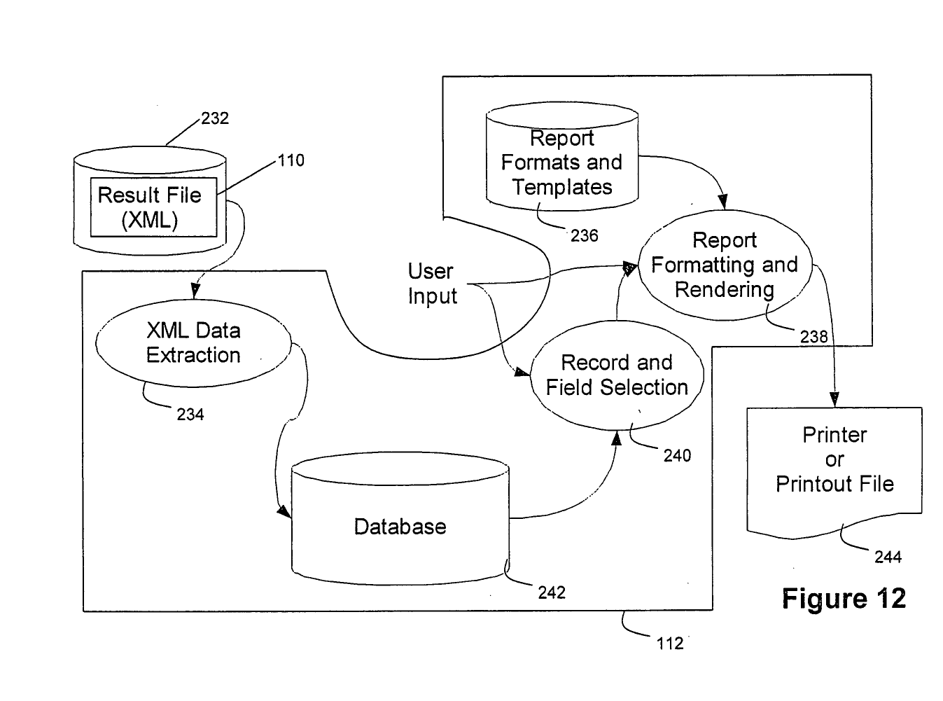

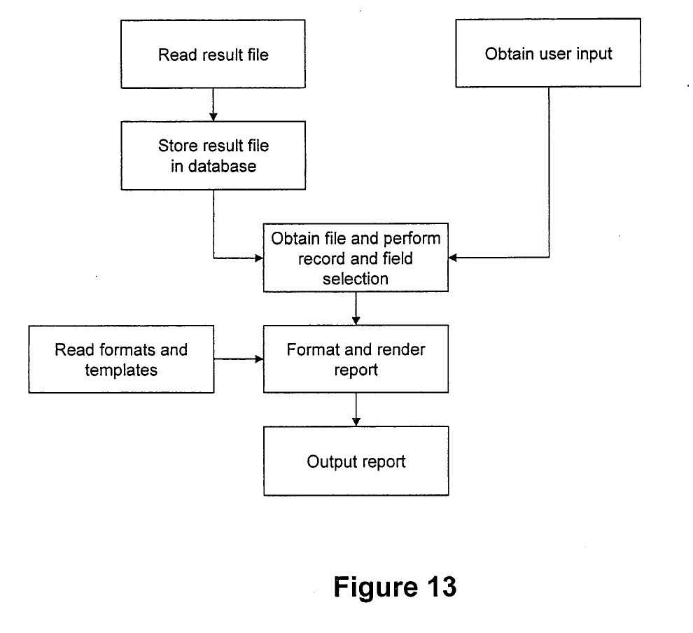

FIGS. 12 and 13 illustrate further detail of the reporting tool 112. The reporting tool 112 obtains, either by physical transport or electronic transmission/exchange, a result file 110 from a data storage module 232. It will be appreciated that the data storage module 232 in this example may comprise a local or remote, physical or virtual file storage which stores the result file 110 to enable it to be obtained by a data extraction module 234. The data extraction module 234 in this example stores the result file 110 locally in a database 242. A database or file storage for report formats and templates 236, along with user input and result file(s) 110 stored in the database 242 are used by record and field selection 240 and report formatting and rendering 238 modules to generate an output 244 for a printer or a printout file. As seen in FIG. 13, upon obtaining the result file 110 and user input, the record and field selection 240 is performed. Formatting and rendering 238 is also performed by reading formats and templates 236, to generate the output 244. The reporting tool 112 may read any number of result files 110 that were generated by the result file generator 108 and store the information in the database 242. The user can select particular tests for reporting and choose data fields from within those result files 110. The user can also dictate the formatting of the report using a template system. The end result is a printed report or equivalent file (e.g. PDF, etc.) containing the specific data from the result file 110 that, e.g. a power utility requires for each type of test.

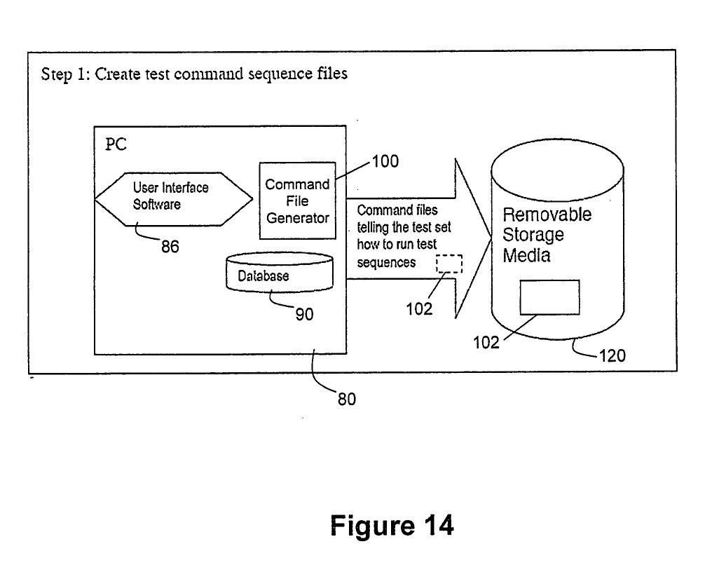

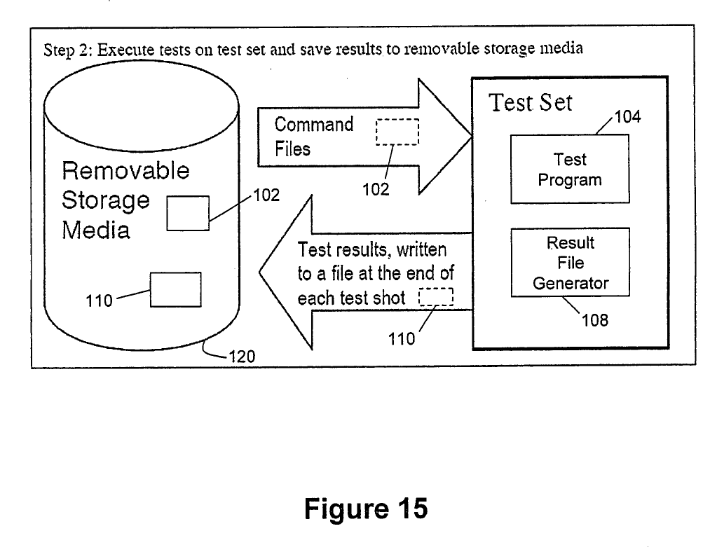

As discussed above, the decoupling shown in FIG. 5 can be accomplished in various ways, including both physical transport of the command files 102 and result files 110, as well as electronic transport. An example will now be provided illustrating the physical transport of command files 102 and report files 110 between the computer 80 and the test set 60 using a removable storage media 120 as shown in FIGS. 14 to 16. Turning first to FIG. 14, the test set 60 is “intelligent” in that it includes a test program 104 and result file generator 108 that are built-in computational hardware and/or software capable of carrying out the execution of test sequences and gathering result data without requiring a connection to the PC 80. The test set 60 should also include non-volatile storage such as flash memory so that it can retain test set commands, test sequences, and result data. By having these capabilities, the test set 60 can rely on a command file 102 comprising the commands and test sequences to first run the test in order to obtain the result data. The PC 80 in this example is used to generate a command file 102 containing the necessary commands and test sequences, e.g. using the command file generator 100 operated via the user interface software 86 and by accessing the database 90 as necessary. The command file 102 may then be uploaded, sent or otherwise transferred directly to removable storage media 102 as shown in FIG. 14. The removable storage media 120 may then be physically transported and connected to the test set 60 as shown in FIG. 15.

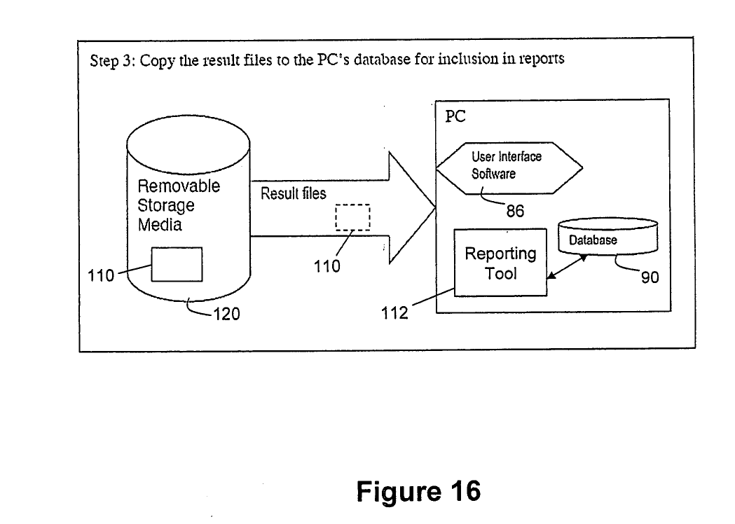

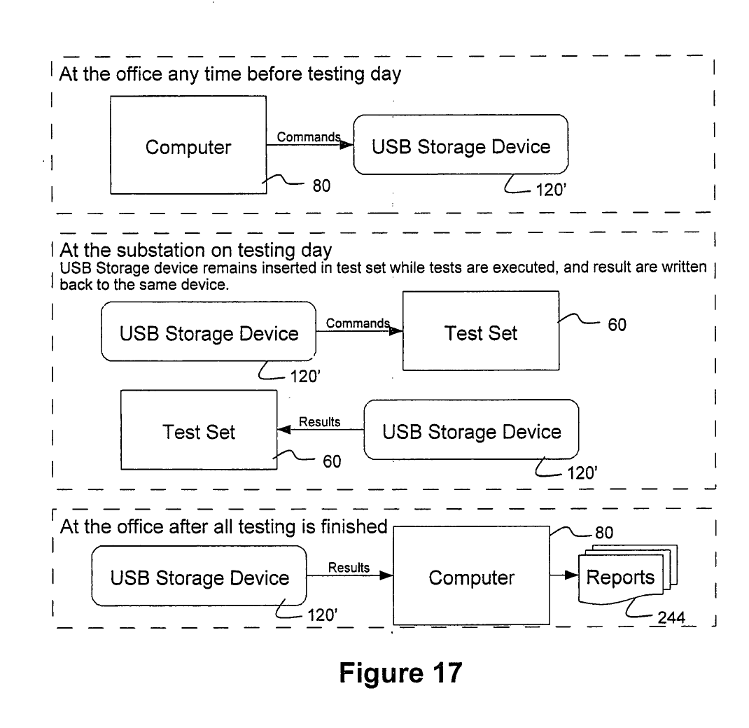

In order to interact with the removable storage media 120, the test set 60 has the ability to transfer data to and from the media 120, e.g via USB or other connection. In this example, a USB flash memory device is used (As also exemplified in FIG. 17). The command files 102 may then be transferred from the removable storage media 120 as shown in FIG. 15, the test run, and the test results written to a result file 110 and stored back to the removable storage media 120. In this way, the removable storage media 120 can be transported back to the PC 80 (or another PC if applicable) as shown in FIG. 16, wherein the result file(s) 110 can be downloaded by the reporting tool 112 for subsequent analysis and reporting.

This example illustrates that the PC 80, rather than controlling the sequence of operations for each test in real time, produces command files 102 which can be interpreted by the test set 60 in order to control the test sequences. Also, the rather than accumulating events as they occur into result data tables, the PC 80 can interpret result files 110 that have been produced by the intelligent components provided in the test set 60 itself and transported back to the PC 80. Moreover, rather than necessarily having to be tethered to the test set 60 for the duration of the test, the PC 80 can write sequence files (command files 102) to removable storage media 120 (or send directly to the test set 60 over a suitable communication link), and read result files 110 from such removable storage media 120 (or by receiving data over such suitable communication link). The PC 80 may then associate the sequences and the results in its database 90 for consolidate reporting. As noted above, FIG. 17 illustrates a specific example of the steps shown in FIGS. 14 to 16 using a USB connection and a USB removable storage device 120′.

Although exemplified in FIGS. 14 to 16 as utilizing a physical transport via removable storage media 120, it can be appreciated that various other transport mechanisms can be employed, in particular electronic protocols. For example, the command files 102 can be uploaded to, transmitted to or downloaded from the test set 60 itself and stored in internal non-volatile storage. In such an example, the command files 102 may still be transported via removable storage media 120 but rather than reading the command files 102 (and commands) directly from the removable storage media 120, the test set 60 stores them for later use. The transportation of the command files 102 may instead be sent via Ethernet, Bluetooth, infrared, other near-field communication methods, Wi-Fi, etc. Similarly, the test 60 may, if possible, maintain a connection to a corporate LAN or WAN and thus obtain command files and provide result files as needed or by accessing a remote service.

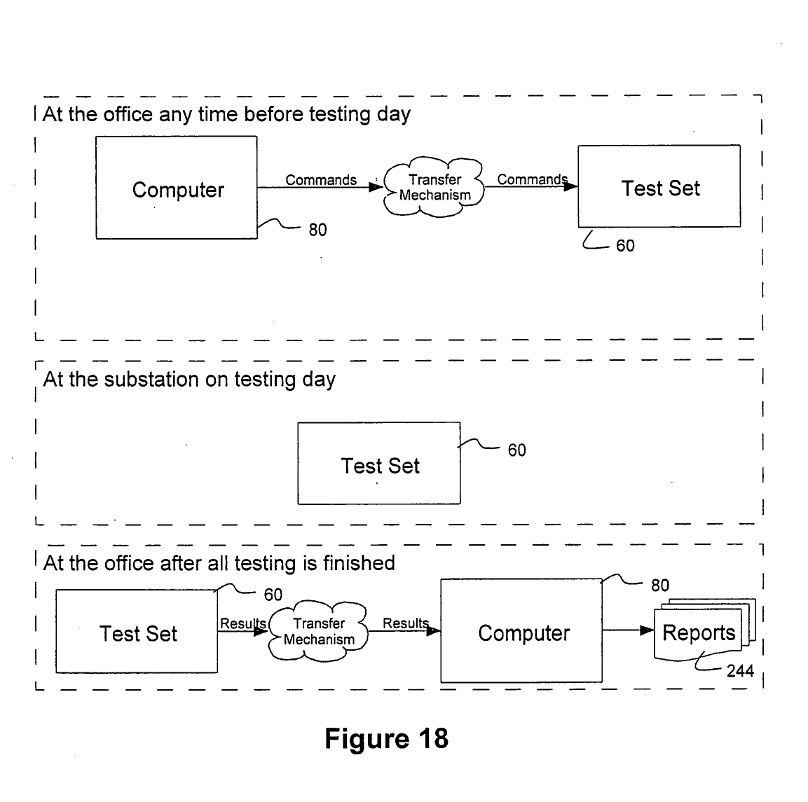

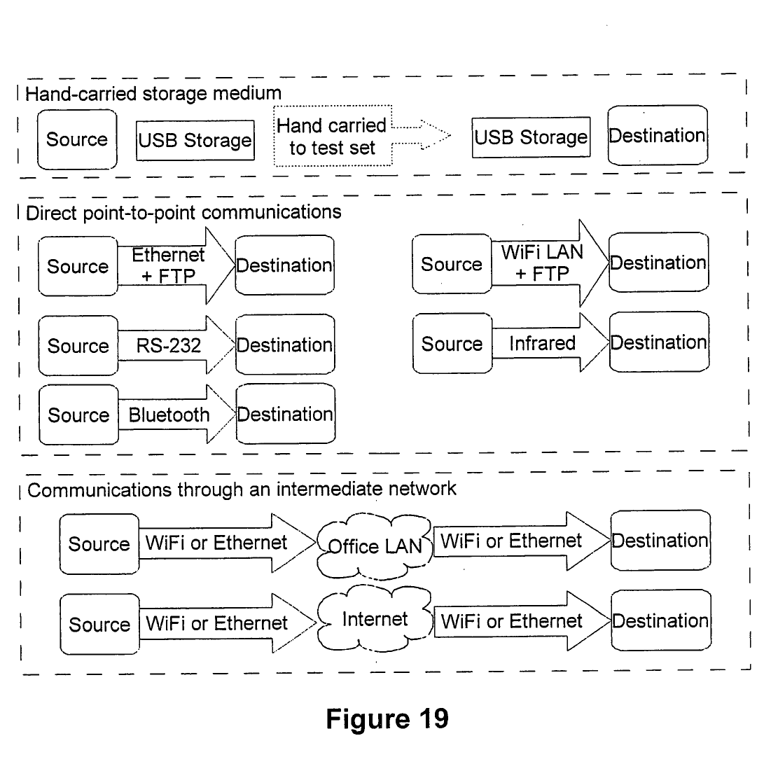

FIG. 18 illustrates a variation on the example shown in FIG. 17, wherein any transfer mechanism may be used. Herein, “transfer mechanism”, as noted above, may be any mechanism or media that allows transfer of files between the computer 80 and the test set 60 as shown in FIG. 18. FIG. 19 illustrates various examples of such transfer mechanisms. As shown in FIG. 18, all tests run using only the test set 60 in these examples, since the command files 102 are sent in advance or otherwise separately. Commands are then taken from files resident in the test set 60 and results are saved to an internal storage for subsequent transfer back to the computer 80.

It can therefore be seen that to avoid the need to tether a computer 80 to a test set 60 in order to run a test sequence and obtain result data, a decoupling can be performed by generating command files 102 that can be placed in storage media 120 or provided to the test set 60 separately rather than sending timed commands directly from the computer 80 to the test set 60. Similarly, a result file generator 108 on the test set 60 can obtain test results and generate a result file 110 that can be placed in such storage media 120 or transported separately to be used by a reporting tool 112 on the computer 80 in the normal fashion. It can be appreciated that, as exemplified above, various ways of decoupling are possible, using any suitable transport scheme including physical and electronic, both wired and wireless.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be, for example, part of the computer 80, test set 60, or accessible or connectable thereto. Any application or module herein described may be implemented using computer readable/executable instructions that may be stored or otherwise held by such computer readable media.

Although the invention has been described with reference to certain specific embodiments, various modifications thereof will be apparent to those skilled in the art without departing from the spirit and scope of the invention as outlined in the claims appended hereto.

1. A method for performing protective relay testing, the method comprising:
a test program operable with a test set obtaining a command file, the command file comprising a test case description;
the test program using the command file to enable the test set to run a test on a protective relay via a test interface;
the test program obtaining from the test interface, events associated with the test being run on the protective relay; and
the test program providing the events to a result file generate for generating a result file indicative of results of the test, wherein the result file is configured to enable a separate computer to generate a report.

2. The method according to claim 1, wherein the test program enables the test set to run the test by determining a test sequence from the test case description, and providing waveform generation parameters to be provided to the protective relay via the test interface for generating waveforms in performance of the test.

3. The method according to claim 1, further comprising generating the result file by accumulating result data, obtaining test settings, and converting the result data according to the test settings to obtain a particular format for the result file.

4. The method according to claim 3, wherein the particular format is XML.

5. The method according to claim 3, further comprising obtaining annotation setting values and incorporating such values into the result file.

6. The method according to claim 1, wherein the command file is obtained from a removable storage medium communicatively coupled to the test program, and wherein the removable storage medium is further communicatively coupled to the result file generator to enable the result file to be stored thereon.

7. The method according to claim 1, wherein the command file is obtained via a data communication link between the test program and a remote computer.

8. A method for enabling the performance of protective relay testing, the method comprising:
obtaining a test set definition indicative of operations to be performed by a test set for the protective relay testing;
obtaining a test case description indicative of the nature of the test to be performed;
generating a command file comprising a test case description by converting the test case description from an internal format to a format understood by the test set using the test set definition; and
outputting the command file to enable the command file to be provided to the test set.

9. The method according to claim 8, further comprising obtaining a result file, the result file being indicative of a test run on a protective relay as indicated by events obtained from the protective relay, the test being run using the command file; and using the result file to generate a report.

10. The method according to claim 9, further comprising extracting data from the result file, formatting and rendering the report according to report formats and templates, and outputting the report to enable the report to be displayed or printed.

11. The method according to claim 10, further comprising enabling record and field selection from the extracted data according to user input.

12. The method according to claim 8, wherein the command file is output to a removable storage medium communicatively coupled to a computer executing instructions for performing the method.

13. The method according to claim 8, wherein the command file is provided to the test set via a data communication link between a computer executing instructions for performing the method and the test set.

14. A computer readable storage medium comprising computer executable instructions for performing protective relay testing, the computer readable storage medium comprising instructions for:
obtaining a command file, the command file comprising a test case description;
using the command file to enable the test set to run a test on a protective relay via a test interface;
obtaining from the test interface, events associated with the test being run on the protective relay; and
providing the events to a result file generate for generating a result file indicative of results of the test, wherein the result file is configured to enable a separate computer to generate a report.

15. A computer readable storage medium comprising computer executable instructions for enabling the performance of protective relay testing, the computer readable storage medium comprising instructions for:
obtaining a test set definition indicative of operations to be performed by a test set for the protective relay testing;
obtaining a test case description indicative of the nature of the test to be performed;
generating a command file comprising a test case description by converting the test case description from an internal format to a format understood by the test set using the test set definition; and
outputting the command file to enable the command file to be provided to the test set.
